(19) United States
(12) Patent Application Publication
(10) Pub. No.: US 2004/0004455 A1
(43) Pub. Date: Jan. 8, 2004

(54) Method and apparatus for detecting stationary rotor angle of sensorless brushless DC motor, and starting method and apparatus using the same

(75) Inventors: Hiromitsu Fujimoto, Kawasaki-Shi (JP); Motoharu Nagase, Tokyo (JP)

Correspondence Address: YOUNG & THOMPSON, 745 SOUTH 23RD STREET 2ND FLOOR, ARLINGTON, VA, 22202

(73) Assignees: NEC ELECTRONICS CORPORATION, KAWASAKI-SHI (JP); NEC CORPORATION, TOKYO (JP)

(21) Appl. No.: 10/602,063

(22) Filed: Jun. 24, 2003

(30) Foreign Application Priority Data
Jul. 5, 2002 (JP) 2002-196787

(51) Int. Cl. H02P 3/00

(52) U.S. Cl. 318/474

(57) ABSTRACT

In a sensorless brushless DC motor formed by a stator including a plurality of windings and a rotor including permanent magnet poles, inductances of the windings are detected while the rotor is stationary, and then, the angle of the stationary rotor is detected in accordance with the detected inductances.

### BACKGROUND OF THE INVENTION

1. Field of the Invention

The present invention relates to a sensorless brushless direct current (DC) motor, and more particularly, to a method and apparatus for detecting a stationary rotor angle of the motor and a method and apparatus for starting the motor after the stationary rotor angle is detected.

2. Description of the Related Art

A sensorless brushless DC motor is a brushless DC motor formed by a stator including windings and a rotor without rotor angle detecting sensors such as Hall sensors.

In a prior art sensorless brushless DC motor (see: JP-A-4-183252), in a steady mode, the windings of the stator are supplied with currents in synchronization with a detected rotor angle by back-electromotive forces generated in the windings by the rotor which is currently being rotated. On the other hand, in a start mode, pulses of a high frequency signal are supplied to the windings of the stator. In this case, the rotor cannot be rotated; however, the rotor is vibrated at the frequency of the high frequency signal. As a result, back-electromotive forces are generated in the windings of the stator, so that the rotor angle can be determined. This will be explained later in detail.

In the above-described prior art driving apparatus, however, since the frequency of the high time constant circuit has to be brought close to a characteristic oscillation frequency of the rotor, an oscillation circuit for generating the above-mentioned high frequency signal has to be adjusted for each rotor, which would increase the manufacturing cost.

### SUMMARY OF THE INVENTION

It is an object of the present invention to provide a method and apparatus for detecting a stationary rotor angle of a sensorless brushless DC motor without generating pulses of a high frequency signal whose frequency is close to a characteristic frequency of a rotor.

Another object is to provide a method and apparatus for starting a sensorless brushless DC motor without generating pulses of a high frequency signal whose frequency is close to a characteristic frequency of a rotor.

According to the present invention, in a method for detecting an angle of a stationary rotor of a sensorless brushless DC motor formed by a stator including a plurality of windings and the rotor including permanent magnet poles, inductances of the windings are detected while the rotor is stationary, and then, the angle of the stationary rotor is detected in accordance with the detected inductances.

Also, in a method for starting a sensorless brushless DC motor formed by a stator including a plurality of windings and a rotor including permanent magnet poles, the rotor is rotated by supplying a sequence of driving current phases to the windings. First, inductances of the windings are detected while the sequence of driving current phases are supplied to the windings and the rotor is stationary. Then, an angle of the rotor is detected in accordance with the detected inductances. In this case, the detected angle of the rotor corresponds to a stable stop point of one of the driving current phases. Then, a first start driving current phase is supplied to the windings. The first start driving current phase is immediately after the one of the driving current phases. Finally, a second start driving current phase is supplied to the windings. In this case, the second start driving current phase is immediately after the first start driving current phase.

### BRIEF DESCRIPTION OF THE DRAWINGS

The present invention will be more clearly understood from the description set forth below, as compared with the prior art, with reference to the accompanying drawings, wherein:

FIG. 1 is a block circuit diagram illustrating a prior art apparatus for driving a sensorless brushless DC motor;

FIG. 2 is a timing diagram for explaining the normal operation of the three-phase bridge circuit of FIG. 1;

FIG. 3 is a circuit diagram illustrating a first embodiment of the apparatus for driving a sensorless brushless DC motor according to the present invention;

FIG. 4 is a flowchart for explaining the operation of the control circuit of FIG. 3;

FIG. 5 is a table for showing the driving phases of the DC motor of FIG. 3;

FIG. 6 is a timing diagram illustrating torque characteristics of the DC motor of FIG. 3;

FIG. 7 is a timing diagram for explaining the comparators of FIG. 3;

FIGS. 8A and 8B are diagrams for explaining inductances of the windings of FIG. 3;

FIGS. 9, 10A, 10B, 11A, 11B, 12, 13A, 13B, 14A and 14B are timing diagrams for explaining the flowchart of FIG. 4; and

FIG. 15 is a circuit diagram illustrating a second embodiment of the apparatus for driving a sensorless brushless DC motor according to the present invention.

### DESCRIPTION OF THE PREFERRED EMBODIMENTS

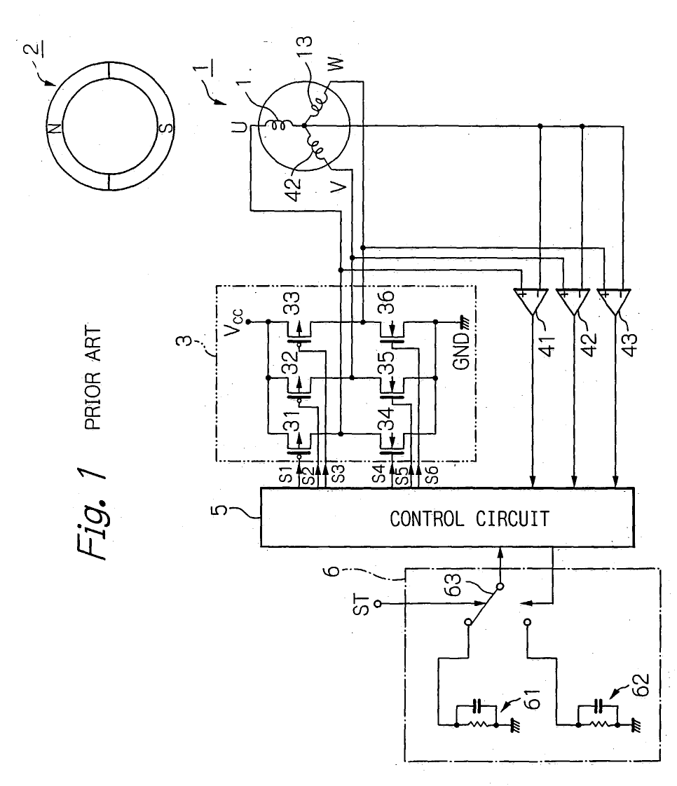

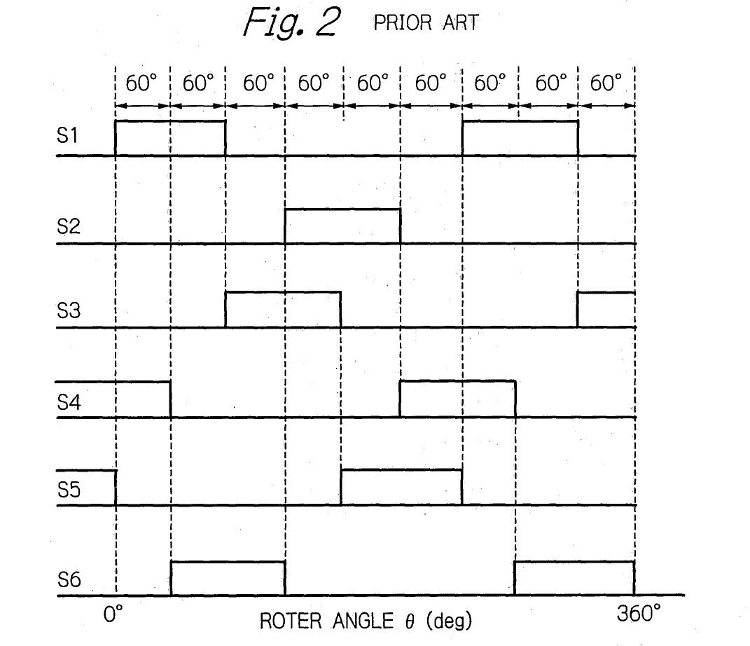

Before the description of the preferred embodiments, a prior art apparatus for driving sensorless brushless DC motor will be explained with reference to FIGS. 1 and 2.

In FIG. 1, which illustrates a prior art apparatus for driving a sensorless brushless DC motor (see: JP-A-4-183252), reference numeral 1 designates a stator having a U-phase winding 11, a V-phase winding 12 and a W-phase winding b3, and 2 designates a rotor having two permanent magnet poles.

A three-phase bridge circuit 3 for supplying currents to the windings 11, 12 and 13 is a serial-parallel circuit formed by P-channel power MOSFETs 31, 32 and 33 and N-channel power MOSFETs 34, 35 and 36.

Amplifiers 41, 42 and 43 for detecting back-electromotive forces generated in the windings 11, 12 and 13, respectively, are connected to the windings 11, 12 and 13. Note that even when the windings 11, 12 and 14 are supplied with currents by-the three-phase bridge circuit 3, no current flows through at least one of the windings 11, 12 and 13. In this case, a back-electromotive force is generated in the one of the windings 11, 12 and 13 by the rotor 2 which is currently being rotated. Thus, the angle θ of the rotor 2 can be determined by the output signals of the amplifiers 41, 42 and 43.

The three-phase bridge circuit 3 and the amplifiers 41, 42 and 43 are connected to a control circuit 5 which is constructed by a microcomputer.

Thus, in a steady mode where the rotor 2 is being rotated, the control circuit 5 generates control signals S1, S2, S3, S4, S5 and S6 for the MOSFETs 31, 32, 33, 34, 35 and 36, respectively, as shown in FIG. 2 in accordance with the rotor angle θ determined by the output signals of the amplifiers 41, 42 and 43, so that the rotor 2 can be forward-rotated at a definite speed.

On the other hand, in a start mode, since the rotor 2 is not rotated, no back-electromotive force is generated in any of the windings 11, 12 and 13. Therefore, it is impossible to detect the rotor angle θ as in the steady mode. In order to detect the rotor angle θ in the start mode, an oscillation circuit 6 is provided.

The oscillation circuit 6 is constructed by a high time constant circuit 61 for generating a high frequency signal, a low time constant circuit 62 for generating a low frequency signal, and a switch circuit 63 for switching the high time constant circuit 61 and the low time constant circuit 62. That is, when a start signal ST is supplied to the oscillation circuit 6, the switch circuit 63 selects the high time constant circuit 61, so that pulses of a high frequency signal are supplied via the control circuit 5 to the windings 11, 12 and 13. In this case, the rotor 2 cannot be rotated; however, the rotor 2 is vibrated at the frequency of the high frequency signal. As a result, back-electromotive forces are generated in the windings 11, 12 and 13, so that the control circuit 5 can determine the rotor angle θ. Thereafter, the control circuit 5 controls the switch circuit 63 so that the switch circuit 63 selects the low frequency time constant circuit 62, thus entering a steady mode using the pulses of the low frequency signal without backward-rotating the rotor 2.

In the driving apparatus of FIG. 1, however, since the frequency of the high time constant circuit 61 has to be brought close to a characteristic oscillation frequency of the rotor 2, the oscillation circuit 6 has to be adjusted for each rotor, which would increase the manufacturing cost.

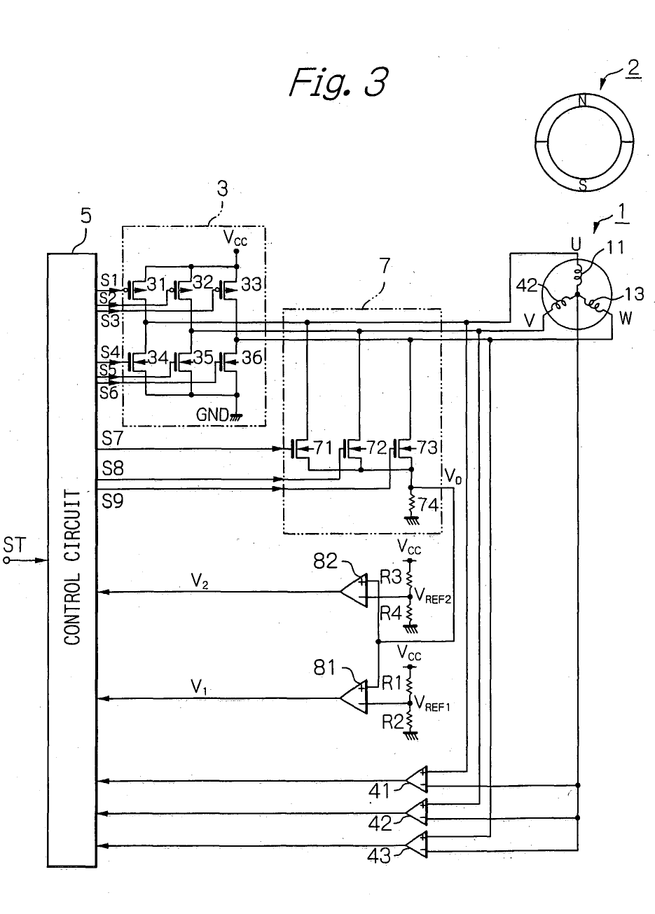

In FIG. 3, which illustrates a first embodiment of the apparatus for driving a sensorless brushless DC motor according to the present invention, a three-phase bridge circuit 7 and comparators 81 and 82 are provided instead of the switch circuit 5 of FIG. 1. Note that the start signal ST is supplied directly to the control circuit 5, and the low time constant circuit 62 of FIG. 1 may be incorporated into the control circuit 5.

The three-phase bridge circuit 7 is constructed by N-channel power MOSFETs 71, 72 and 73 and a resistor 74. Note that, in a start mode, the N-channel power MOSFETs 71, 72 and 73 serve as the N-channel power MOSFETs 34, 35 and 36, respectively, of the three-phase bridge circuit 3.

The comparators 81 and 82 compare an output voltage V_{D} of the three-phase bridge circuit 7 with reference voltages V_{REF1} and V_{REF2} (V_{REF1}<V_{REF2}), respectively. The reference voltages V_{REF1} and V_{REF2} are generated by voltage dividers (R1, R2) and (R3, R4), respectively.

In a steady state, in the same way as in the apparatus of FIG. 1, the control circuit 5 generates the control signals S1, S2, S3, S4, S5 and S6 for the MOSFETs 31, 32, 33, 34, 35 and 36 as shown in FIG. 2 in accordance with the rotor angle θ determined by the output signals of the amplifiers 41, 42, and 43, so that the rotor 2 can be forward-rotated at a definite speed.

On the other hand, in a start mode, the control circuit 5 generates control signals S1, S2, S3, S7, S8 and S9 for the MOSFETs 31, 32, 33, 71, 72 and 73, respectively, to detect the stationary rotor angle θ in accordance with the output signals V₁ and V₂ of the comparators 81 and 82. Then, the control circuit 5 drives the rotor 2 in a forward rotation in accordance with the detected stationary rotor angel θ.

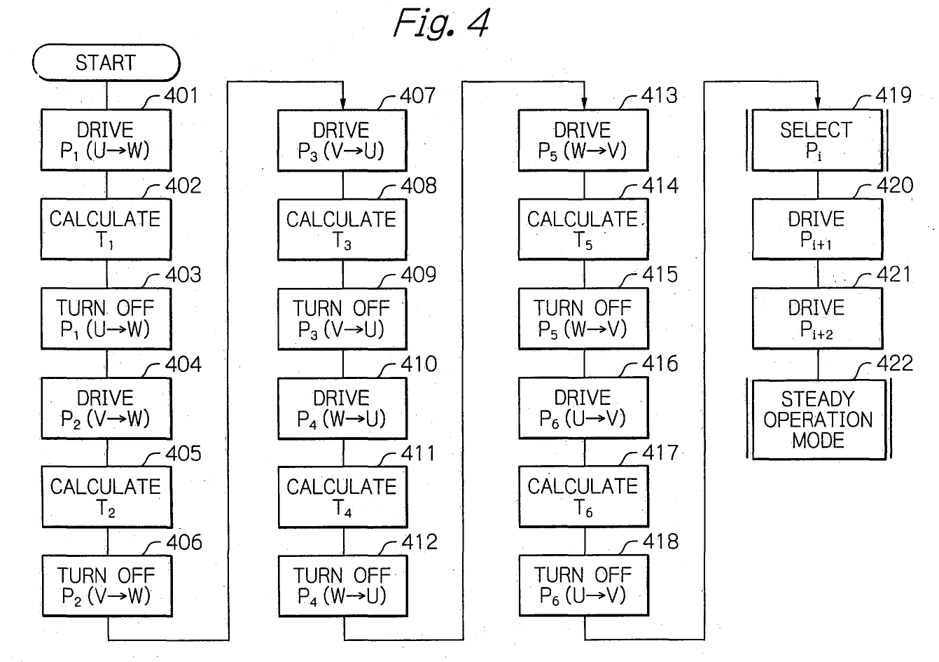

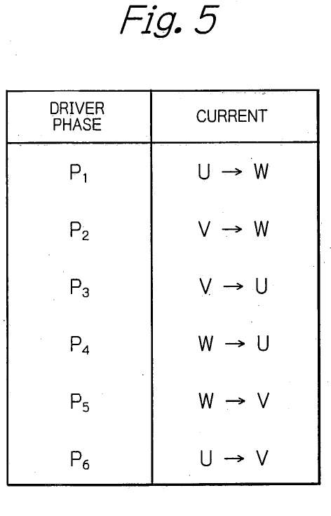

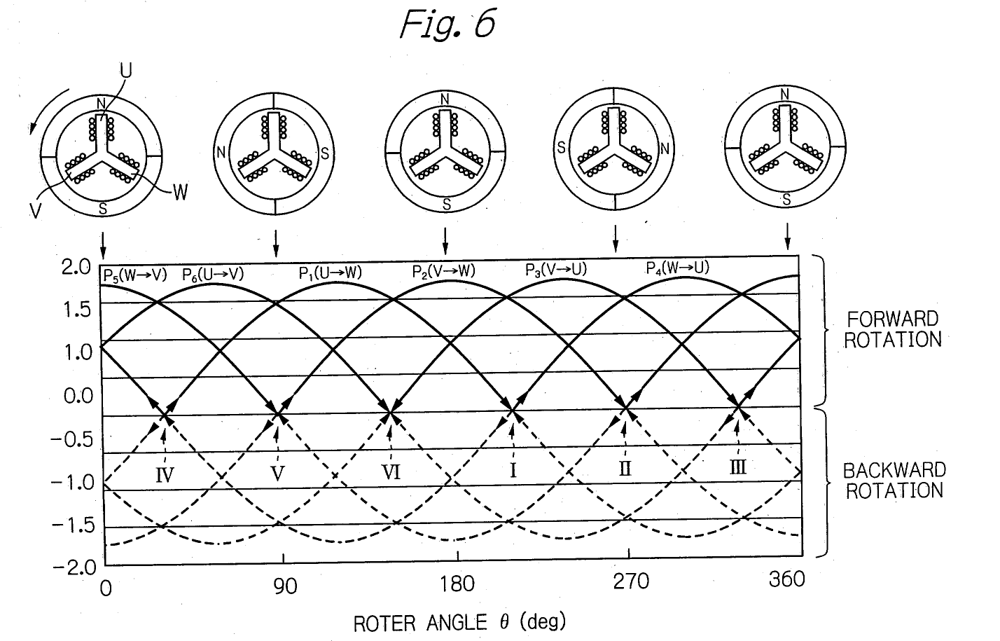

The operation of the control circuit 5 of FIG. 3 will be explained next with reference to FIG. 4. The flowchart of FIG. 4 is started by receiving the start signal ST. Note that driving phases P₁, P₂, . . . , P₆ are defined by currents as shown in FIG. 5, and the torque characteristics of the DC motor with respect to the driving phases P₁, P₂, . . . , P₆ are shown in FIG. 6.

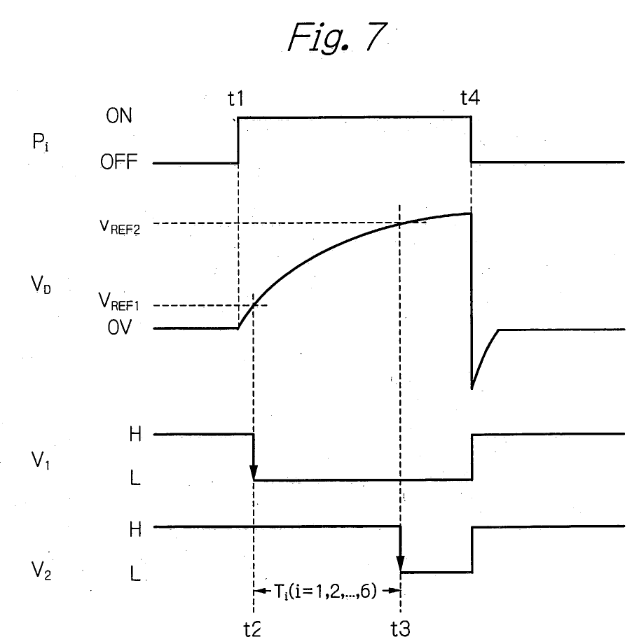

First, at step 401 (see t1 of FIG. 7), the phase P1 (U→W) is driven, i.e., the control signals S1 and S9 are made “1” (high) so that the windings 11 and 13 are turned ON. As a result, a current flows from the MOSFET 31 through the windings 11 and 13 to the MOSFET 73, so that the output voltage V_{D} of the three-phase bridge circuit 7 is changed as shown in FIG. 7. In this case, the output voltage V_{D} is represented by

V_{D}=(V_{CC}·R₀/R₁)(1−exp(−R₁t/L₁))

where Vc is a power supply voltage;

R₀ is the resistance value of the resistor 74;

R₁ is a combined resistance value of the ON-resistance value of the MOSFETs 33 and 73, the resistance value of the windings 11 and 13 and the resistance value R₀ of the resistor 75; and

L₁ is an inductance of the windings 11 and 13.

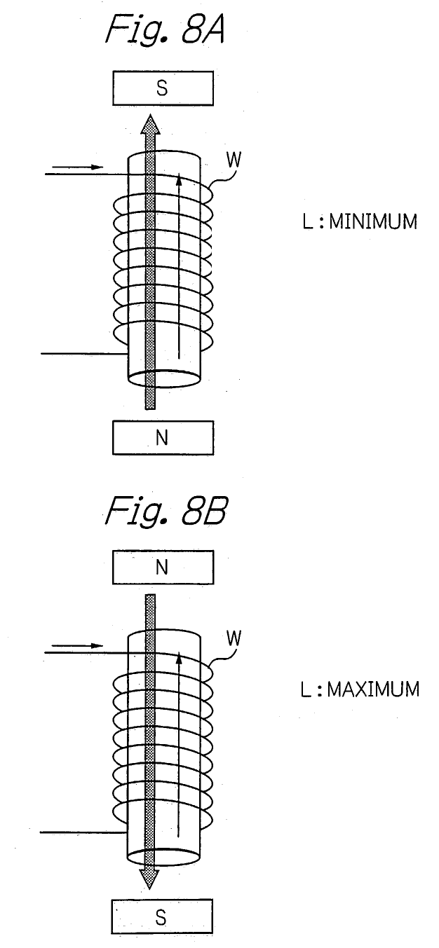

The resistance value of the resistor R₀ and the combined resistance R₁ are almost constant regardless of the rotor angle θ; however, the inductance L₁ of the windings 11 and 13 is affected by the rotor angle θ. That is, as shown in FIG. 8A, when the direction of a magnetic flux induced by a current flowing through a winding W coincides with that of a magnetic flux induced by the rotor 2, the inductance of the winding W is minimum. On the other hand, as shown in FIG. 8B, when the direction of a magnetic flux induced by a current flowing through the winding W is opposite to that of a magnetic flux induced by the rotor 2, the inductance of the winding W is maximum.

Next, at step 402, a time t2 from a timing when the output signal V₁ of the comparator 81 falls is detected, and a time t3 when the output signal V₂ of the comparator 82 falls is detected. Then, a time period T₁(=t3−t2) as shown in FIG. 7 is calculated.

Next, at step 403 (see t4 of FIG. 7), the control signals S1 and S9 are made “0” (low), so that the windings 11 and 13 are turned OFF.

Next, at step 404 (see t1 of FIG. 7), the phase P2 (V→W) is driven, i.e., the control signals S2 and S9 are made “1” (high) so that the windings 12 and 13 are turned ON. As a result, a current flows from the MOSFET 32 through the windings 12 and 13 to the MOSFET 73, so that the output voltage VD of the three-phase bridge circuit 7 is changed as shown in FIG. 7. In this case, the output voltage VD is substantially represented by

V_{D}=(V_{CC}·R₀/R₁)(1−exp(−R₁t/L₂))

where L₂ is an inductance of the windings 12 and 13.

Next, at step 405, a time t2 from a timing when the output signal V₁ of the comparator 81 falls is detected, and a time t3 when the output signal V₂ of the comparator 82 falls is detected. Then, a time period T₂(=t3−t2) as shown in FIG. 7 is calculated.

Next, at step 406 (see t4 of FIG. 7), the control signals S2 and S9 are made “0” (low), so that the windings 12 and 13 are turned OFF.

Next, at step 407 (see t1 of FIG. 7), the phase P₃ (V→U) is driven, i.e., the control signals S2 and S7 are made “1” (high) so that the windings 12 and 11 are turned ON. As a result, a current flows from the MOSFET 32 through the windings 12 and 11 to the MOSFET 71, so that the output voltage V_{D} of the three-phase bridge circuit 7 is changed as shown in FIG. 7. In this case, the output voltage V_{D} is substantially represented by

V_{D}=(V_{CC}·R₀/R₁)(1−exp(−R₁t/L₃))

where L₃ is an inductance of the windings 12 and 11.

Next, at step 408, a time t2 from a timing when the output signal V₁ of the comparator 81 falls is detected, and a time t3 when the output signal V₂ of the comparator 82 falls is detected. Then, a time period T₃(=t3−t2) as shown in FIG. 7 is calculated.

Next, at step 409 (see t4 of FIG. 6), the control signals S2 and S7 are made “O” (low), so that the windings 12 and 11 are turned OFF.

Next, at step 410 (see t1 of FIG. 7), the phase P₄ (W→U) is driven, i.e., the control signals S3 and S7 are made “1” (high) so that the windings 13 and 11 are turned ON. As a result, a current flows from the MOSFET 33 through the windings 13 and 11 to the MOSFET 71, so that the output voltage V_{D} of the three-phase bridge circuit 7 is changed as shown in FIG. 7. In this case, the output voltage V_{D} is substantially represented by

V_{D}=(V_{CC}·R₀/R₁)(1−exp(−R₁t/L₄))

where L₄ is an inductance of the windings 13 and 11.

Next, at step 411, a time t2 from a timing when the output signal V₁ of the comparator 81 falls is detected, and a time t3 when the output signal V₂ of the comparator 82 falls is detected. Then, a time period T₄(=t3−t2) as shown in FIG. 7 is calculated.

Next, at step 412 (see t4 of FIG. 7), the control signals S3 and S7 are made “0” (low), so that the windings 13 and 11 are turned OFF.

Next, at step 413 (see t1 of FIG. 7), the phase Pₛ (W→V) is driven, i.e., the control signals S3 and S8 are made “1” (high) so that the windings 13 and 12 are turned ON. As a result, a current flows from the MOSFET 33 through the windings 13 and 12 to the MOSFET 72, so that the output voltage V_{D} of the three-phase bridge circuit 7 is changed as shown in FIG. 7. In this case, the output voltage V_{D} is substantially represented by

V_{D}=(V_{CC}·R₀/R₁)(1−exp(−R₁t/L₅))

where L₅ is an inductance of the windings 13 and 12.

Next, at step 414, a time t2 from a timing when the output signal V₁ of the comparator 81 falls is detected, and a time t3 when the output signal V₂ of the comparator 82 falls is detected. Then, a time period T₅(=t3−t2) as shown in FIG. 7 is calculated.

Next, at step 415 (see t4 of FIG. 7), the control signals S3 and S8 are made “0” (low), so that the windings 13 and 12 are turned OFF.

Next, at step 416 (see t1 of FIG. 7), the phase P₅ (U→V) is driven, i.e., the control signals S1 and S8 are made “1” (high) so that the windings 11 and 12 are turned ON. As a result, a current flows from the MOSFET 31 through the windings 11 and 12 to the MOSFET 72, so that the output voltage V_{D} of the three-phase bridge circuit 7 is changed as shown in FIG. 7. In this case, the output voltage V_{D} is substantially represented by

V_{D}=(V_{CC}·R₀/R₁)(1−exp(−R₁t/L₆))

where L₆ is an inductance of the windings 11 and 12.

Next, at step 417, a time t2 from a timing when the output signal V₁ of the comparator 81 falls is detected, and a time t3 when the output signal V₂ of the comparator 82 falls is detected. Then, a time period T₆(=t3−t2) as shown in FIG. 7 is calculated.

Next, at step 418 (see t4 of FIG. 7), the control signals S1 and S8 are made “0” (low), so that the windings 11 and 12 are turned OFF.

Next, at step 419, the control circuit 5 selects one of the phases P₁, P₂, P₃, P₄, P₅ and P₆ having a minimum value of the time periods T₁, T₂, T₃, T₄, T₅ and T₆, i.e., a minimum inductance with respect to the rotor 2. For example, when the time period T₁ is minimum, the rotor 2 stably stops at a location I as indicated in FIG. 6. Also, when the time period T₂ is minimum, the rotor 2 stably stops at a location II as indicated in FIG. 6. Further, when the time period T₃ is minimum, the rotor 2 stably stops at a location III as indicated in FIG. 6. Further, when the time period T₄ is minimum, the rotor 2 stably stops at a location IV as indicated in FIG. 6. Additionally, when the time period T₅ is minimum, the rotor 2 stably stops at a location V as indicated in FIG. 6. Still, when the time period T₆ is minimum, the rotor 2 stably stops at a location VI as indicated in FIG. 6.

Next, at step 420, the control circuit 5 drives the phase Pᵢ₊₁ ahead of the phase Pᵢ. Thereafter, at step 421, the control circuit 5 drives the phase Pᵢ₊₂ ahead of the phase Pᵢ₊₁, Note that i is mod [6]. Therefore, if i+1>6, “i+1” is caused to be “i+1−6”, and if i+2 >6, “i+2” is caused to be “i+2−6”. For example, Pᵢ indicates Pᵢ where a current flows from the U-phase winding 11 to the W-phase winding 13, a current first flows from the V-phase winding 12 to the W-phase winding 13 (phase P₂), and then, a current flows from the V-phase winding 12 to the U-phase winding 11 (phase P₃). Thus, a start mode is completed, so that the rotor 2 is forward-rotated.

Finally, at step 422, the control enters a steady mode using the output signals of the amplifiers 41, 42 and 43 to control the three-phase bridge circuit 3.

The provision of step 421 without step 420 is explained below. That is, assume the control at step 419 proceeds directly to step 421.

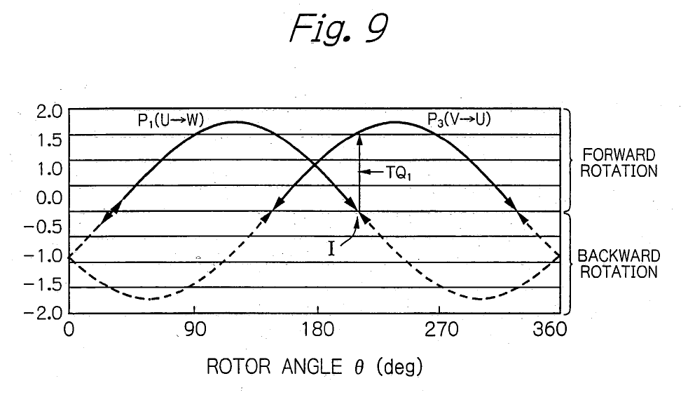

For example, as shown in FIG. 9, when the phase P₁ (U→W) has a minimum inductance, so that the rotor 2 stably stops at a location I indicated in FIG. 9, the control circuit 5 drives the phase P₃ (V→U) two phases after the phase P₁ (U→W). Even in this case, a large torque as indicated by TQ₁ in FIG. 9 is generated in the rotor 2, so that the rotor 2 can be effectively forward-rotated without step 420.

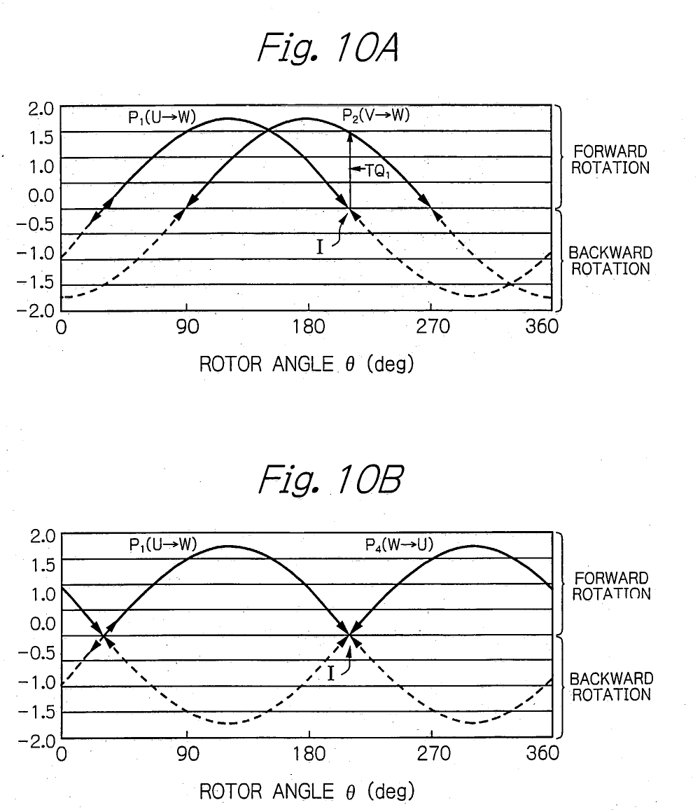

Next, as shown in FIG. 10A, although the phase P₁ (U→W) has a minimum inductance, the phase P₆ (U→W) adjacent to the phase P₁ may erroneously be selected at step 419. Even in this case, when the control circuit 5 drives the phase P₂ (V→W) two phases after the phase P₆ (U→V), a large torque as indicated by TQ₁ in FIG. 10A is generated in the rotor 2, so that the rotor 2 can be effectively forward-rotated without step 420.

Next, as shown in FIG. 10B, although the phase P₁ (U→W) has a minimum inductance, the phase P₂ (V→W) adjacent to the phase P₁ may erroneously be selected at step 419. In this case, when the control circuit 5 drives the phase P₄ (U→W) two phases after the phase P₂ (U→W), no torque as indicated in FIG. 10B is generated in the rotor 2, so that the rotor 2 cannot be forward-rotated without step 420.

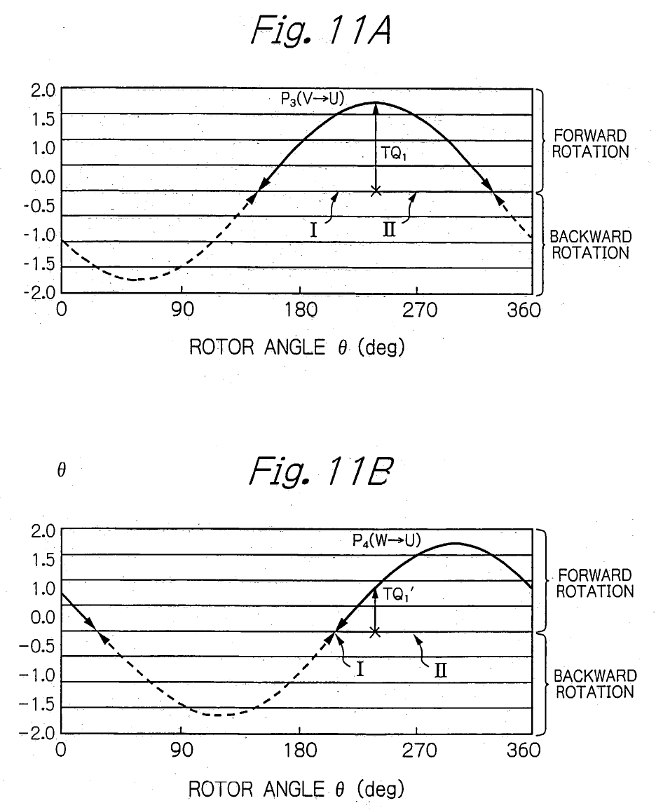

Next, as shown in FIGS. 11A and 11B, the rotor 2 actually stops at an intermediate location indicated by X between the location I and II. In this case, the phase P₁ (U→W) or P₂ (V→W) is selected at step 419. When the phase P₁ (U→W) is selected, the control circuit 5 drives the phase P₃ (V→U) two phases after the phase P₁ (U→W), a large torque as indicated by TQ₁ in FIG. 11A is generated in the rotor 2, so that the rotor 2 can be effectively forward-rotated without step 420. On the other hand, when the phase P₂(V→W) is selected, the control circuit 5 drives the phase P₄ (V→U) two phases after the phase P₁ (W→U), a torque as indicated by TQ₁′ in FIG. 11B smaller than the torque TQ₁ is generated in the rotor 2, so that the rotor 2 can be forward-rotated at any rate without step 420.

Thus, if step 420 is not provided, the rotor 2 may not be forward-rotated.

The provision of step 421 along with step 420 is explained below. That is, assume the control at step 419 proceeds via step 420 to step 421.

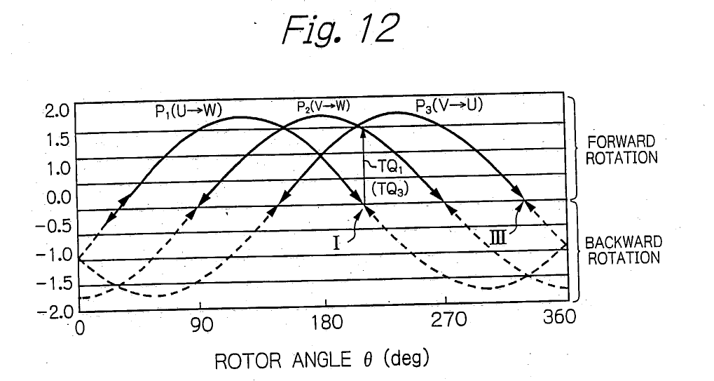

For example, as shown in FIG. 12, when the phase P₁ (U→W) has a minimum inductance, so that the rotor 2 stably stops at a location I indicated in FIG. 12, the control circuit 5 first drives the phase P₂ (V→W) one phase after the phase P₁ (U→W). Even in this case, a large torque as indicated by TQ₁ in FIG. 12 is generated in the rotor 2. Subsequently, the control circuit 5 drives the phase P₃ (V→U) one phase after the phase P₂ (V→W). Even in this case, a large torque as indicated by TQ₂ in FIG. 12 is generated in the rotor 2. Thus, the rotor 2 can be effectively forward-rotated.

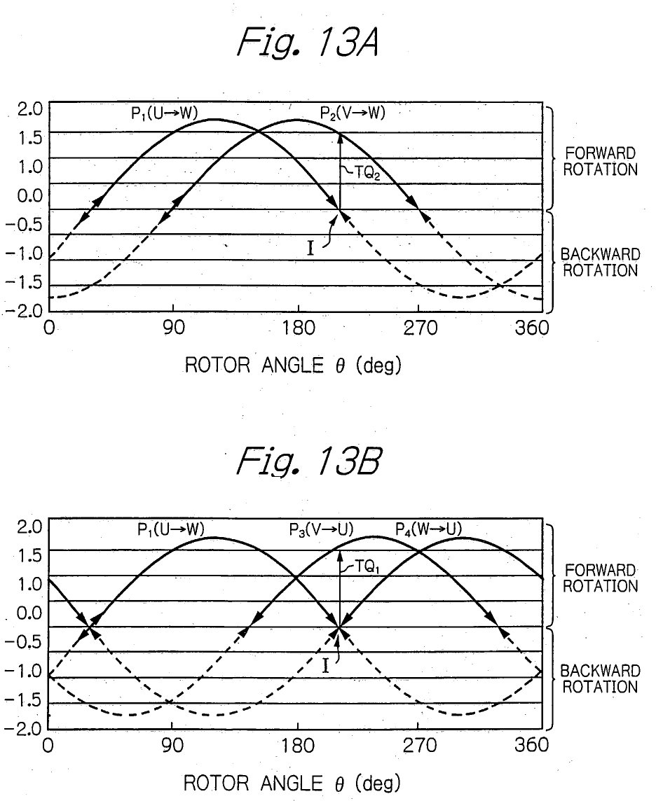

Next, as shown in FIG. 13A, although the phase P₁ (U→W) has a minimum inductance, the phase P₆ (U→W) adjacent to the phase P₁ may erroneously be selected at step 419. In this case, the control circuit 5 first drives the phase P₁ (U→W) one phase after the phase P₆ (U→V), so that no torque is generated in the rotor 2. Subsequently, the control circuit 5 drives the phase P₂ (V→W) one phase after the phase P₁ (U→W), so that a large torque as indicated by TQ₂ in FIG. 13A is generated in the rotor 2. Thus, the rotor 2 can be effectively forward-rotated.

Next, as shown in FIG. 13B, although the phase P₁ (U→W) has a minimum inductance, the phase P₂ (V→W) adjacent to the phase P₁ may erroneously be selected at step 419. In this case, the control circuit 5 first drives the phase P₃ (V→U) one phase after the phase P₂ (V→W), so that a large torque as indicated by TQ₁ in FIG. 13B is generated in the rotor 2. Subsequently, the control circuit 5 drives the phase P₄ (U→W) one phase after the phase P₃ (V→U), so that no torque as indicated in FIG. 13B is generated in the rotor 2. Thus, the rotor 2 can be effectively forward-rotated.

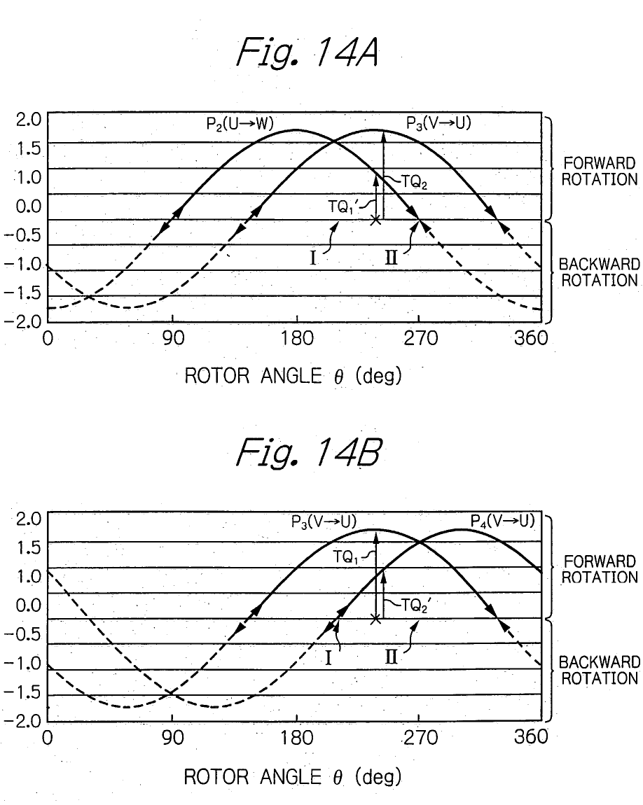

Next, as shown in FIGS. 14A and 14B, the rotor 2 actually stops at an intermediate location indicated by X between the location I and II. In this case, the phase P₁ (U→W) or P₂ (V→W) is selected at step 419. When the phase P₁ (U→W) is selected, the control circuit 5 first drives the phase P₂ (V→W) one phase after the phase P₁ (U→W), so that a torque indicated by TQ₁′ smaller than the torque TQ₁ is generated in the rotor 2. Subsequently, the control circuit 5 drives the phase P₃ (V→U) one phase after the phase P₂ (V→W), so that a large torque as indicated by TQ₂ in FIG. 14A is generated in the rotor 2. Thus, the rotor 2 can be effectively forward-rotated. On the other hand, when the phase P₂ (V→W) is selected, the control circuit 5 first drives the phase P₃ (V→U) after the phase P₂ (V→W), so that a large torque as indicated by TQ₁ is generated in the rotor 2. Subsequently, the control circuit 5 drives the phase P₄ (V→U) one phase after the phase P₃ (V→U), SO that a torque as indicated by TQ₂′ in FIG. 14B smaller than the torque TQ₂ is generated in the rotor 2. Thus, the rotor 2 can be effectively forward-rotated.

Thus, if step 420 is provided, the rotor 2 can be completely forward-rotated.

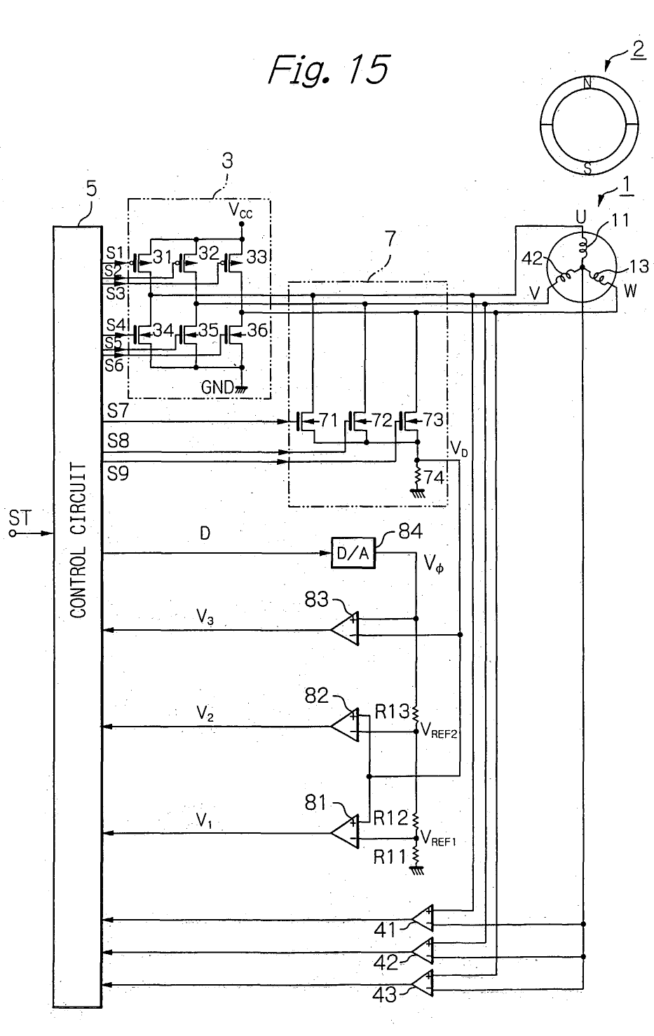

In FIG. 15, which illustrates a second embodiment of the apparatus for driving a senserless brushless DC motor according to the present invention, a comparator 83 and a digital-to-analog (D/A) converter 84 are added to the elements of FIG. 3, and a voltage divider formed by resistors R11, R12 and R13 is provided instead of the voltage dividers (R1, R2) and (R3, R4). In FIG. 3, the reference voltages V_{REF1} and V_{REF2} are constant, while, in FIG. 15, the reference voltages V_{REF1} and V_{REF2} are variable and determined by the output voltage V_{P} of the D/A converter 84. The D/A converter 84 is operated by the control circuit 5 using an initial routine. That is, in the initial routine, one phase such as P₁ is driven for a predetermined time period. As a result, the control circuit 5 receives the output voltage V₃ of the comparator 83. In this case, when V_{P}<V_{D}, the output voltage V₃ of the comparator 83 is made “1” (high). As a result, the control circuit 5 continues to increase input data D to the D/A converter 84 until V₃ is made “0” (low), i.e., until the output voltage V_{P} coincides with the output voltage V_{D} of the three-phase bridge circuit 7 (V_{P}=V_{D}). Thus, the output voltage V_{P} of the D/A converter 84 serving as a power supply voltage to the voltage divider (R11, R12, R13) is determined in accordance with the peak value of the output voltage V_{D} of the three-phase bridge circuit 7 independent of the power supply voltage V_{cc}, which is helpful in detection of optimum inductances.

In the above-described embodiments, an outer rotor type DC motor is illustrated; however, the present invention can be applied to an inner rotor type DC motor. Also, the rotor 2 can have four or more permanent magnet poles.

As explained hereinabove, according to the present invention, the stationary rotor angle of a sensorless brushless DC motor can be started without a high time constant circuit whose frequency is close to a characteristic frequency of a rotor. Also, the sensorless brushless DC motor can be surely started in a forward-rotation direction.

1. A method for detecting an angle of a stationary rotor of a sensorless brushless DC motor comprising a stator including a plurality of windings, said rotor including permanent magnet poles, comprising steps of:
detecting inductances of said windings while said rotor is stationary; and
detecting the angle of said stationary rotor in accordance with said detected inductances.

2. The method-as set forth in claim 1, wherein said stationary rotor angle detecting step detects the angle of said stationary rotor in accordance with a respective one of said windings having a minimum value of said detected inductances.

3. The method as set forth in claim 1, wherein said inductance detecting step comprises the steps of:
supplying currents to said windings; and
detecting transient phenomena of said currents,
thus detecting said inductances in accordance with the transient phenomena of said currents.

4. A method for detecting an angle of a stationary rotor of a sensorless brushless DC motor, said DC motor comprising a stator including a star connection of a U-phase winding, a V-phase winding and a W-phase winding, said rotor including permanent magnet poles, comprising the steps of:
detecting a first inductance of said U-phase winding and said W-phase winding when a first current flows from said U-phase winding to said W-phase winding when said rotor is stationary;
detecting a second inductance of said V-phase winding and said W-phase winding when a second current flows from said V-phase winding to said W-phase winding when said rotor is stationary;
detecting a third inductance of said V-phase winding and said U-phase winding when a third current flows from said V-phase winding to said U-phase winding when said rotor is stationary;
detecting a fourth inductance of said W-phase winding and said U-phase winding when a fourth current flows from said W-phase winding to said U-phase winding when said rotor is stationary;
detecting a fifth inductance of said W-phase winding and said V-phase winding when a fifth current flows from said W-phase winding to said V-phase winding when said rotor is stationary;
detecting a sixth inductance of said U-phase winding and said V-phase winding when a sixth current flows from said U-phase winding to said V-phase winding when said rotor is stationary; and
detecting the angle of said stationary rotor in accordance with said first, second, third, fourth, fifth and sixth inductances.

5. The method as set forth in claim 4, wherein said stationary rotor angle detecting step comprises a step of detecting a minimum value of said first, second, third, fourth, fifth and sixth inductances, thus detecting the angle of said stationary rotor in accordance with said minimum value.

6. An apparatus for detecting an angle of a stationary rotor of a sensorless brushless DC motor comprising a stator including a plurality of windings, said rotor including permanent magnet poles, comprising:
an inductance detecting circuit for detecting inductances of said windings while said rotor is stationary; and
a stationary rotor angle detecting circuit, connected to said inductance detecting circuit, for detecting the angle of said stationary rotor in accordance with said detected inductances.

7. The apparatus as set forth in claim 6, wherein said inductance detecting circuit comprises:
a three-phase bridge circuit, connected to said windings, for supplying currents to said windings, said three-phase bridge circuit including a resistor connected in series to said windings to generate a plurality of detection voltages each corresponding to one of said inductances;
a first comparator, connected to said resistor, for comparing each of said detection voltages with a first reference voltage to generate a first timing signal when each of said detection voltages becomes higher than said first reference voltage; and
a second comparator, connected to said resistor, for comparing each of said detection voltages with a second reference voltage higher than said first reference voltage to generate a second timing signal when each of said detection voltages becomes higher than said second reference voltage,
said inductances being defined by time periods each beginning at a time when said first comparator generates said first timing signal and ending at a time when said second comparator generates said second timing signal.

8. The apparatus as set forth in claim 7, wherein said stationary rotor angle detecting circuit detects the angle of said stationary rotor in accordance with a respective one of said windings having a minimum value of said time periods.

9. The apparatus as set forth in claim 7, wherein said first and second reference voltages are determined by a power supply voltage.

10. The apparatus as set forth in claim 7, wherein said first and second reference voltages are variable independent of a power supply voltage.

11. An apparatus for detecting an angle of a stationary rotor of a sensorless brushless DC motor comprising a stator including a star connection of a U-phase winding, a V-phase winding and a W-phase winding, said rotor including permanent magnet poles, comprising:
a three-phase bridge circuit, connected to said windings, for supplying currents to said windings, said three-phase bridge circuit including a resistor connected in series to said windings to generate a detection voltage corresponding to an inductance of two of said windings;
a first comparator, connected to said resistor, for comparing said detection voltage with a first reference voltage to generate a first timing signal when said detection voltage becomes higher than said first reference voltage;
a second comparator, connected to said resistor, for comparing said detection voltage with a second reference voltage higher than said first reference voltage to generate a second timing signal when said detection voltage becomes higher than said second reference voltage, said inductance being defined by a time period beginning at a time when said first comparator generates said first timing signal; and ending at a time when said second comparator generates said second timing signal; and
a stationary rotor angle detecting circuit, connected to said first and second comparators, for detecting a first inductance of said U-phase winding and said W-phase winding when a first current flows from said U-phase winding to said W-phase winding when said rotor is stationary, detecting a second inductance of said V-phase winding and said W-phase winding when a second current flows from said V-phase winding to said W-phase winding when said rotor is stationary, detecting a third inductance of said V-phase winding and said U-phase winding when a third current flows from said V-phase winding to said U-phase winding when said rotor is stationary, detecting a fourth inductance of said W-phase winding and said U-phase winding when a fourth current flows from said W-phase winding to said U-phase winding when said rotor is stationary, detecting a fifth inductance of said W-phase winding and said V-phase winding when a fifth current flows from said W-phase winding to said V-phase winding when said rotor is stationary, detecting a sixth inductance of said U-phase winding and said V-phase winding when a sixth current flows from said U-phase winding to said V-phase winding when said rotor is stationary, and detecting the angle of said stationary rotor in accordance with said first, second, third, fourth, fifth and sixth inductances.

12. The apparatus as set forth in claim 11, wherein said stationary rotor angle detecting circuit detects a minimum value of said first, second, third, fourth, fifth and sixth inductances, thus detecting the angle of said stationary rotor in accordance with said minimum value.

13. The apparatus as set forth in claim 11, wherein said first and second reference voltages are determined by a power supply voltage.

14. The apparatus as set forth in claim 11, wherein said first and second reference voltages are variable independent of a power supply voltage.

15. A method for starting a sensorless brushless DC motor comprising a stator including a plurality of windings and a rotor including permanent magnet poles, said rotor being rotated by supplying a sequence of driving current phases to said windings, comprising steps of:
detecting inductances of said windings while said sequence of driving current phases are supplied to said windings and said rotor is stationary;
detecting an angle of said rotor in accordance with said detected inductances, the detected angle of said rotor corresponding to a stable stop point of one of said driving current phases,
supplying a first start driving current phase to said windings, said first start driving current phase being immediately after the one of said driving current phases; and
supplying a second start driving current phase to said windings after said first driving current phase is supplied, said second start driving current phase being immediately after said first start driving current phase.

16. The method as set forth in claim 15, wherein said stationary rotor angle detecting step detects the angle of said rotor in accordance with a respective one of said sequence of driving currents having a minimum value of said detected inductances.

17. The method as set forth in claim 15, wherein said inductance detecting step detects said inductances in accordance with a transient phenomena of said driving current phases.

18. A method for starting a sensorless brushless DC motor, comprising a stator including a star connection of a U-phase winding, a V-phase winding and a W-phase winding, and a rotor including permanent magnet poles, comprising the steps of:
detecting a first inductance of said U-phase winding and said W-phase winding when a first driving current phase flows from said U-phase winding to said W-phase winding when said rotor is stationary;
detecting a second inductance of said V-phase winding and said W-phase winding when a second driving current phase flows from said V-phase winding to said W-phase winding when said rotor is stationary;
detecting a third inductance of said V-phase winding and said U-phase winding when a third driving current phase flows from said V-phase winding to said U-phase winding when said rotor is stationary;
detecting a fourth inductance of said W-phase winding and said U-phase winding when a fourth driving current phase flows from said W-phase winding to said U-phase winding when said rotor is stationary;
detecting a fifth inductance of said W-phase winding and said V-phase winding when a fifth driving current phase flows from said W-phase winding to said V-phase winding when said rotor is stationary;
detecting a sixth inductance of said U-phase winding and said V-phase winding when a sixth current flows from said U-phase winding to said V-phase winding when said rotor is stationary;
detecting an angle of said rotor in accordance with said first, second, third, fourth, fifth and sixth inductances, the detected angle of said rotor corresponding to a stable stop point of one of said first, second, third, fourth, fifth and sixth driving current phases;
supplying a first start driving current phase to said U-phase winding, said V-phase winding and said W-phase winding, said first start driving current phase being immediately after the one of said first, second, third, fourth, fifth and sixth driving current phases; and
supplying a second start driving current phase to said U-phase winding, said V-phase winding and said U-phase winding, after said first start driving current phase is supplied, said second start driving current phase being immediately after said first start driving phase.

19. An apparatus for starting a sensorless brushless DC motor comprising a stator including a plurality of windings and a rotor including permanent magnet poles, said rotor being rotated by supplying a sequence of driving current phases to said windings, comprising:
an inductance detecting circuit for detecting inductances of said windings while said sequence of driving current phases are supplied to said windings and said rotor is stationary;
a stationary rotor angle detecting circuit, connected to said inductance detecting circuit, for detecting an angle of said rotor in accordance with said detected inductances, the detected angle of said rotor corresponding to a stable stop point of one of said driving current phases, supplying a first start driving current phase to said windings, said first start driving current phase being immediately after the one of said driving current phases, and supplying a second start driving current phase to said windings after said first start driving current is supplied, said second start driving current phase being immediately after said first start driving current phases.

20. The apparatus as set forth in claim 19, wherein said inductance detecting circuit comprises:
a three-phase bridge circuit, connected to said windings, for supplying said driving current phases to said windings, said three-phase bridge circuit including a resistor connected in series to said windings to generate a plurality of detection voltages each corresponding to one of said inductances;
a first comparator, connected to said resistor, for comparing each of said detection voltages with a first reference voltage to generate a first timing signal when each of said detection voltages becomes higher than said first reference voltage; and
a second comparator, connected to said resistor, for comparing each of said detection voltages with a second reference voltage higher than said first reference voltage to generate a second timing signal when each of said detection voltages becomes higher than said second reference voltage,
said inductances being defined by time periods each beginning at a time when said first comparator generates said first timing signal and ending at a time when said second comparator generates said second timing signal.

21. The apparatus as set forth in claim 20, wherein said stationary rotor angle detecting circuit detects the angle of said rotor in accordance with a respective one of said windings having a minimum value of said time periods.

22. The apparatus as set forth in claim 20, wherein said first and second reference voltages are determined by a power supply voltage.

23. The apparatus as set forth in claim 20, wherein said first and second reference voltages are variable independent of a power supply voltage.

24. An apparatus for starting a sensorless brushless DC motor comprising a stator including a star connection of a U-phase winding, a V-phase winding and a W-phase winding, and a rotor including permanent magnet poles, comprising:
a three-phase bridge circuit, connected to said windings, for supplying currents to said windings, said three-phase bridge circuit including a resistor connected in series to said windings to generate a detection voltage corresponding to an inductance of two of said windings;
a first comparator, connected to said resistor, for comparing said detection voltage with a first reference voltage to generate a first timing signal when said detection voltage becomes higher than said first reference voltage;
a second comparator, connected to said resistor, for comparing said detection voltage with a second reference voltage higher than said first reference voltage to generate a second timing signal when said detection voltage becomes higher than said second reference voltage, said inductance being defined by a time period beginning at a time when said first comparator generates said first timing signal and ending at a time when said second comparator generates said second timing signal, detecting a sixth inductance of said U-phase winding and said V-phase winding when a sixth driving current phase flows from said U-phase winding to said V-phase winding when said rotor is stationary, detecting an angle of said rotor in accordance with said first, second, third, fourth, fifth and sixth inductances, the detected angle of said rotor corresponding to a stable stop point of one of said first, second, third, fourth, fifth and sixth driving current phases; and
a stationary rotor angle detecting circuit, connected to said first and second comparators, for detecting a first inductance of said U-phase winding and said W-phase winding when a driving current phase flows from said U-phase winding to said W-phase winding when said rotor is stationary, detecting a second inductance of said V-phase winding and said W-phase winding when a second driving current phase flows from said V-phase winding to said W-phase winding when said rotor is stationary, detecting a third inductance of said V-phase winding and said U-phase winding when a third driving current phase flows from said V-phase winding to said U-phase winding when said rotor is stationary, detecting a fourth inductance of said W-phase winding and said U-phase winding when a fourth driving current phase flows from said W-phase winding to said U-phase winding when said rotor is stationary, detecting a fifth inductance of said W-phase winding and said V-phase winding when a fifth driving current phase flows from said W-phase winding to said V-phase winding when said rotor is stationary, supplying a first start driving current phase to said U-phase winding, said V-phase winding and W-phase winding, said first start driving current phase being immediately after the one of said first, second, third, fourth, fifth and sixth driving current phases, and supplying a second start driving current phase to said U-phase winding, said V-phase winding and W-phase winding after said first start driving current phase is supplied, said second start driving current phase being immediately after said first start driving current phase.

25. The apparatus as set forth in claim 24, wherein said stationary rotor angle detecting circuit detects a minimum value of said first, second, third, fourth, fifth and sixth inductances, thus detecting the angle of said rotor in accordance with said minimum value.

26. The apparatus as set forth in claim 24, wherein said first and second reference voltages are determined by a power supply voltage.

27. The apparatus as set forth in claim 24, wherein said first and second reference voltages are variable independent of a power supply voltage.
